(19) United States
(12) Patent Application Publication
(10) Pub. No.: US 2023/0396086 A1
(43) Pub. Date: Dec. 7, 2023

(54) POWER SUPPLY SYSTEM, CONTROL METHOD, AND STORAGE MEDIUM

(71) Applicant: HONDA MOTOR CO., LTD., Tokyo (JP)

(72) Inventor: Tsuyoshi Iguchi, Wako-shi (JP)

(21) Appl. No.: 18/204,407

(22) Filed: Jun. 1, 2023

(30) Foreign Application Priority Data
Jun. 6, 2022 (JP) 2022-091460

(51) Int. Cl. H02J 7/00; H01M 8/04858; H01M 8/04225; H02M 3/158

(52) U.S. Cl. CPC H02J 7/0063; H01M 8/04865; H02J 7/007; H02M 3/1584; H01M 8/04225

(57) ABSTRACT

A power supply system includes one or more fuel cell outputs, each including a fuel cell and a voltage converter that converts an output voltage of the fuel cell, a voltage adjuster connected in parallel with the one or more fuel cell outputs to a load, the voltage adjuster including a diode and a regenerative DC power supply, and a control device that controls the one or more fuel cell outputs and the voltage adjuster, wherein the control device performs, after activating the fuel cell, limiting control through the voltage adjuster such that the voltage of each of the one or more fuel cell outputs becomes a target value and starts power supply from the one or more fuel cell outputs to the load when the voltage of each of the one or more fuel cell outputs reaches the target value.

### CROSS-REFERENCE TO RELATED APPLICATION

Priority is claimed on Japanese Patent Application No. 2022-091460, filed Jun. 6, 2022, the content of which is incorporated herein by reference.

### BACKGROUND

### Field of the Invention

The present invention relates to a power supply system, a control method, and a storage medium.

### Description of Related Art

In recent years, to ensure access to affordable, reliable, sustainable and advanced energy for more people, research and development has been carried out on fuel cells (FCs) that contribute to energy efficiency. In fuel cell vehicle (FCV) systems or the like, high output responsiveness is required for batteries to cope with transient power fluctuations during travel. With regard to this, a technology in which a storage battery which achieves high responsiveness through FCs is connected in parallel with FCs to cope with transient power fluctuations is known in the related art (for example, Japanese Unexamined Patent Application, First Publication No. 2002-118979).

### SUMMARY

Incidentally, in the technology relating to fuel cells, high output responsiveness is not always required for an FC power generator when the FC system is used as a stationary auxiliary/adjustment power supply, a regular power supply, or the like. Therefore, there has been a demand for a configuration without a storage battery (a storage-battery-less configuration) in the system in cases where high output responsiveness is not required to reduce equipment cost and size. However, since the voltage (DC bus voltage) of the system is determined by the voltage of the storage battery, the voltage of the system becomes uncertain in the storage-battery-less configuration, which may result in a failure to supply appropriate power.

The present invention has been made in view of such circumstances and it is an object of the present invention to provide a power supply system, a control method, and a storage medium that can more appropriately stabilize the voltage even without a storage battery, thus contributing to energy efficiency.

A power supply system, a control method, and a storage medium according to the present invention adopt the following configurations.

(1) A power supply system according to an aspect of the present invention includes one or more fuel cell outputs, each including a fuel cell and a voltage converter configured to convert an output voltage of the fuel cell, a voltage adjuster connected in parallel with the one or more fuel cell outputs to a load, the voltage adjuster including a diode and a regenerative DC power supply, and a control device configured to control the one or more fuel cell outputs and the voltage adjuster, wherein the control device is configured to perform, after activating the fuel cell, limiting control through the voltage adjuster such that a voltage of each of the one or more fuel cell outputs becomes a target value and start power supply from the one or more fuel cell outputs to the load when the voltage of each of the one or more fuel cell outputs reaches the target value.

(2) In aspect (1) above, the control device is configured to perform control such that power is constantly supplied from the fuel cell to an auxiliary device connected via the voltage adjuster while the power supply system is active.

(3) In aspect (2) above, the control device is configured to output, to each of the one or more fuel cell outputs, a command for generating a current corresponding to a sum of power supplied to the load and power supplied to the auxiliary device divided by the number of the fuel cell outputs.

(4) In aspect (2) above, the control device is configured to control, after starting power supply from the one or more fuel cell outputs to the load, power output from the one or more fuel cell outputs such that power supplied from the one or more fuel cell outputs is a sum of power supplied to the load and power supplied to the auxiliary device or a value of waste power required for the voltage adjuster to perform limiting control, whichever is higher.

(5) A control method according to another aspect of the present invention is a control method for a power supply system including one or more fuel cell outputs, each including a fuel cell and a voltage converter configured to convert an output voltage of the fuel cell, and a voltage adjuster connected in parallel with the one or more fuel cell outputs to a load, the voltage adjuster including a diode and a regenerative DC power supply, the control method including one or more computers activating the fuel cell, performing limiting control through the voltage adjuster such that a voltage of each of the one or more fuel cell outputs becomes a target value, and starting power supply from the one or more fuel cell outputs to the load when the voltage of each of the one or more fuel cell outputs reaches the target value.

(6) A storage medium according to another aspect of the present invention stores is a computer-readable non-transitory storage medium storing a program for one or more computers in a power supply system including one or more fuel cell outputs, each including a fuel cell and a voltage converter configured to convert an output voltage of the fuel cell, and a voltage adjuster connected in parallel with the one or more fuel cell outputs to a load, the voltage adjuster including a diode and a regenerative DC power supply, the program causing the one or more computers to activate the fuel cell, perform limiting control through the voltage adjuster such that a voltage of each of the one or more fuel cell outputs becomes a target value, and start power supply from the one or more fuel cell outputs to the load when the voltage of each of the one or more fuel cell outputs reaches the target value.

According to aspects (1) to (6) above, the voltage can be stabilized more appropriately even without a storage battery.

### BRIEF DESCRIPTION OF THE DRAWINGS

FIG. 1 is a diagram showing an example of a configuration of a power supply system including a storage battery.

FIG. 2 is a diagram showing an example of a configuration of a storage-battery-less power supply system of an embodiment.

FIG. 3 is a diagram for explaining an example of how control is performed when the power supply system of the embodiment is activated.

FIG. 4 is a flowchart showing an example of a process performed by the power supply system of the embodiment.

### DESCRIPTION OF EMBODIMENTS

Hereinafter, embodiments of a power supply system, a control method, and a storage medium of the present invention will be described with reference to the drawings. A stationary power supply system including fuel cell stacks (FCSs) will be described below as an example of the power supply system.

### Power Supply System Including Storage Battery

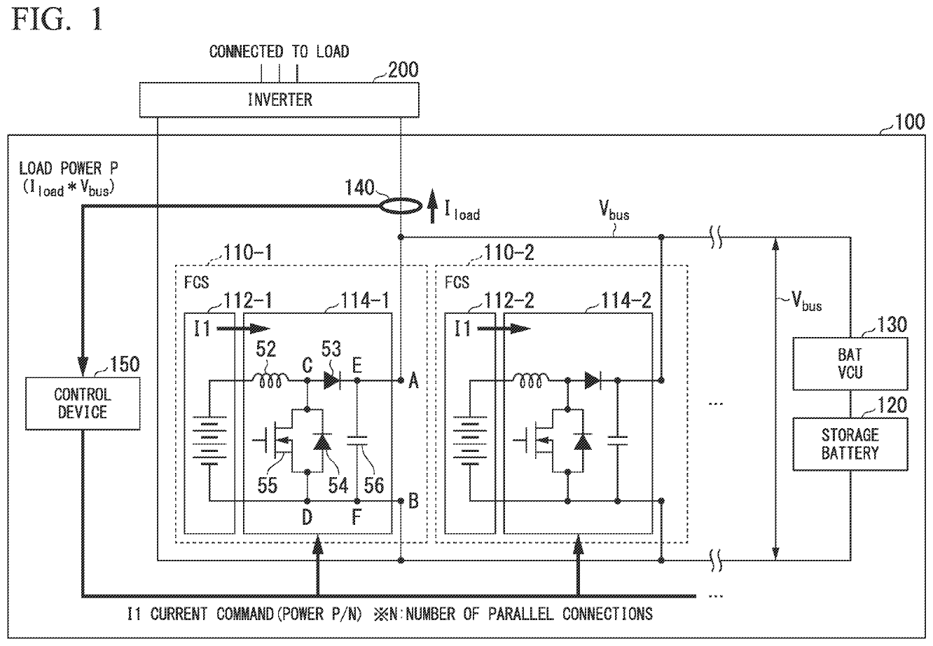

First, a power supply system that includes a storage battery will be described before describing a (storage-battery-less) power supply system that is configured without a storage battery. FIG. 1 is a diagram showing an example of a configuration of a power supply system 100 that includes a storage battery. The power supply system 100 includes, for example, one or more FCSs 110, a storage battery 120, a battery voltage and current control unit (BATVCU) 130, a current sensor 140, and a control device 150. Two FCSs 110-1 and 110-2 are shown in FIG. 1 as examples of one or more FCSs. The FCSs 110-1 and 110-2 are connected in parallel to a load (for example, a power-consuming apparatus, device, or equipment) connected ahead of an inverter 200. The FCSs will each be referred to as an “FCS 110” when they are not particularly distinguished from each other. Each FCS 110 is an example of a “fuel cell output.” Since the two FCSs 110 have the same configuration, a specific configuration will be described using the FCS 110-1.

In the example of FIG. 1, the power supply system 100 is connected to the inverter 200. A load current I_{Load} and a DC bus voltage V_{bus} are output to the inverter 200. The inverter 200 converts DC power output from the power supply system 100 into AC power and outputs the converted AC power to the load.

The FCS 110-1 performs power generation control under the control of the control device 150 which will be described later. The FCS 110-1 includes, for example, a fuel cell (FC) 112-1 and a fuel cell voltage and current control unit (FCVCU) 114-1. The FC 112-1 generates power by chemically reacting hydrogen, which is an example of fuel, with oxygen. The FCVCU 114-1 is an example of a “voltage converter.” A resistor 52 and a diode 53 are connected in series to a positive electrode of the FC 112-1. A cathode of the diode 53 is connected to a terminal A. An anode of the diode 53 is connected to the resistor 52. A diode 54 and a reactor 55 are connected in parallel and are each connected to terminals C and D. The terminal C is a terminal provided between the resistor 52 and the diode 53. The terminal D is a terminal connected to a negative electrode of the FC 112-1. A capacitor 56 is connected to a terminal E and a terminal F. The terminal E is a terminal connected to the cathode of the diode 53. The terminal F is a terminal connected to the negative electrode of the FC 112-1. The FCVCU 114-1 receives a current command from the control device 150 and controls the FCS 110 such that the FCS 110 outputs a current I1 corresponding to the received current command. In the following description, the FCs 112-1 and 112-2 will each be referred to as an “FC 112” when they are not particularly distinguished from each other and the FCVCUs 114-1 and 114-2 will each be referred to as an “FCVCU 114” when they are not particularly distinguished from each other. The FCVCU 114 is an example of a “first voltage converter” that converts an output voltage of a fuel cell.

In the power supply system 100 of FIG. 1, the storage battery 120 and the BATVCU 130 are connected in series and are connected in parallel with the FCSs 110. The storage battery 120 is, for example, a lithium ion battery or an all-solid battery. The storage battery 120 supplies power when the load is connected. The BATVCU 130 is connected in parallel with the FCVCUs 114 to the load. Under the control of the control device 150, the BATVCU 130 converts an output voltage of the storage battery 120 and performs power regeneration for stably supplying the DC bus voltage and limiting an FC open circuit voltage (FC-OCV). The current sensor 140 detects a load current I_{load} output to the inverter 200.

The control device 150 is implemented, for example, by a hardware processor such as a central processing unit (CPU) executing a program (software). Some or all of the above components may be implemented by hardware (including circuitry) such as a large scale integration (LSI), an application specific integrated circuit (ASIC), a field-programmable gate array (FPGA), or a graphics processing unit (GPU) or may be implemented by software and hardware in cooperation. The program may be stored in a storage device (a storage device including a non-transitory storage medium) such as an HDD or a flash memory in advance or may be stored in a detachable storage medium (a non-transitory storage medium) such as a DVD or a CD-ROM and then installed by mounting the storage medium in a drive device.

The control device 150 is a management electronic control unit (ECU) that controls all components of the power supply system 100. For example, the control device 150 obtains a load power P (=I_{load}*V_{bus}) from the load current I_{load} detected by the current sensor 140 and the DC bus voltage V_{bus} and issues a current command for outputting a predetermined current I1 such that each FCS 110 outputs uniform power (with a predetermined tolerance). For example, when N FCSs 110 are connected in parallel, the control device 150 outputs, to each of the FCSs 110, a current command for generating a current I1 such that each FCS 110 outputs the power P divided by the number of parallel connections N (P/N).

Here, in the case of the power supply system 100 as shown in FIG. 1, the DC bus voltage V_{bus} is determined by the voltage of the storage battery 120. Therefore, when the power supply system is configured without a storage battery, the DC bus voltage V_{bus} becomes uncertain and deviates from a predetermined input voltage range of the inverter 200, which may result in a failure to supply a stable voltage. Thus, in an embodiment, a voltage adjuster that adjusts a voltage is provided instead of the storage battery 120 and the BATVCU 130 and power (auxiliary device power) is constantly supplied from the FCs to auxiliary devices connected to the voltage adjuster via the voltage adjuster, thereby stabilizing the DC bus voltage.

### Storage-Battery-Less Power Supply System

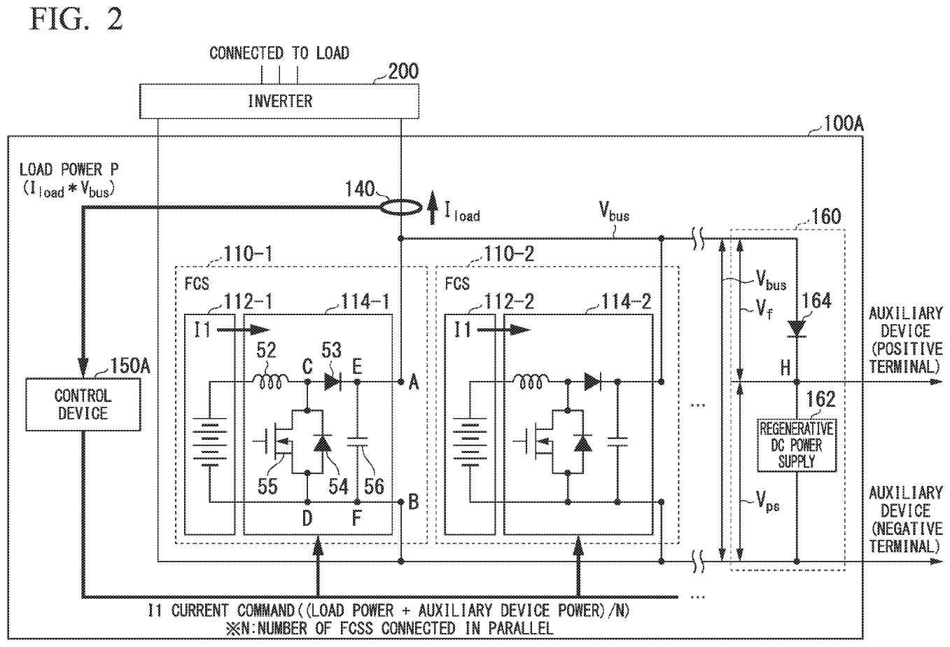

FIG. 2 is a diagram showing an example of a configuration of a storage-battery-less power supply system 100A of the embodiment. In the following, the same names and reference numerals are assigned to the same components as those of the power supply system 100 shown in FIG. 1 and specific descriptions thereof will be given later. The power supply system 100A shown in FIG. 2 includes one or more FCSs 110, a current sensor 140, a control device 150A, and a voltage clamp circuit 160. The power supply system 100A shown in FIG. 2 differs from the power supply system 100 shown in FIG. 1 in that it includes the voltage clamp circuit 160 instead of the storage battery 120 and the BATVCU 130 and the control device 150A instead of the control device 150. Thus, the following description focuses on the voltage clamp circuit 160 and the control device 150A. The voltage clamp circuit 160 is an example of a “voltage adjuster.”

The voltage clamp circuit 160 is connected in parallel with the FCSs 110. The voltage clamp circuit 160 includes, for example, a regenerative DC power supply (bidirectional power supply) 162 and a diode 164. The regenerative DC power supply 162 and the diode 164 are connected in series. One side of the regenerative DC power supply 162 is connected to negative electrodes of the FCSs 110 and another side thereof is connected to a cathode of the diode 164. The diode 164 has an anode connected to positive electrodes of the FCSs 110 and a cathode connected to the regenerative DC power supply 162. The voltage clamp circuit 160 is connected to auxiliary devices. Here, positive terminals of the auxiliary devices are connected to a terminal H between the regenerative DC power supply 162 and the diode 164 and negative terminals of the auxiliary devices are connected to the negative sides of the FCSs 110. The auxiliary devices are, for example, devices relating to the power supply system such as an air pump (not shown) that supplies air to the FCSs 110 to adjust temperature, ECUs (not shown) for the FCSs 110, and the control device 150A. The auxiliary devices may include a device that operates on the same voltage as the regenerative DC power supply 162 and a device that operates on a voltage obtained by adjusting the voltage of the regenerative DC power supply 162 through a DC/DC converter. The DC/DC converter is included, for example, in the voltage clamp circuit 160.

The regenerative DC power supply 162 has the functions of a DC power supply and a DC electronic load. The regenerative DC power supply 162 also has a function of regenerating power to the AC power supply side while the electronic load is operating. The regenerative DC power supply 162 includes, for example, a converter capable of bi-directionally converting DC and AC. Specifically, both a bidirectional DC/DC converter and a bidirectional AC/DC converter can be provided therein to support both direct current and alternating current.

The diode 164 allows a predetermined amount of electricity to flow in the forward direction (from the anode to the cathode) and blocks the flow of electricity in the reverse direction. By supplying power of the FC voltage to the auxiliary devices through the diode 164, stable power can be supplied to the auxiliary devices.

The control device 150A is implemented, for example, by a hardware processor such as a CPU executing a program (software). Some or all of the above components may be implemented by hardware (including circuitry) such as an LSI, an ASIC, an FPGA, or a GPU or may be implemented by software and hardware in cooperation.

The program may be stored in a storage device (a storage device including a non-transitory storage medium) such as an HDD or a flash memory in advance or may be stored in a detachable storage medium (a non-transitory storage medium) such as a DVD or a CD-ROM and then installed by mounting the storage medium in a drive device.

The control device 150A is a management ECU that controls all components of the power supply system 100A. For example, the control device 150A obtains a load power P (=Load*V_{bus}) from the load current I_{load} detected by the current sensor 140 and the DC bus voltage V_{bus} and issues a current command for outputting a predetermined current I1 such that each FCS 110 outputs uniform power. Here, the DC bus voltage V_{bus} of the power supply system 100A can be calculated, for example, from the sum of a forward voltage V_{f} of the diode 164 and a regenerative DC power supply voltage V p s (V_{bus}=V_{f}+Vₚₛ). For example, when N FCSs 110 are connected in parallel, the control device 150A outputs, to each of the FCSs 110, a current command for generating a current I1 such that each FCS 110 outputs the sum of the load power P and auxiliary power divided by the number of parallel connections N ((load power P+auxiliary power)/N).

The control device 150A performs OCV limiting control. OCV limiting control is, for example, control that, if the voltage of each FC 112 becomes greater than a threshold (an OCV limiting voltage), causes the voltage of each FC 112 (the FC voltage) to be output (consumed) to prevent the voltage from exceeding the threshold, because deterioration of the FCs 112 progress if the voltages of the FCs 112 are too high. The control device 150A acquires the voltage of an FC 110 from each of the one or more FCSs 110 at regular intervals or at a predetermined timing and performs a threshold-based determination process using the acquired FC voltage.

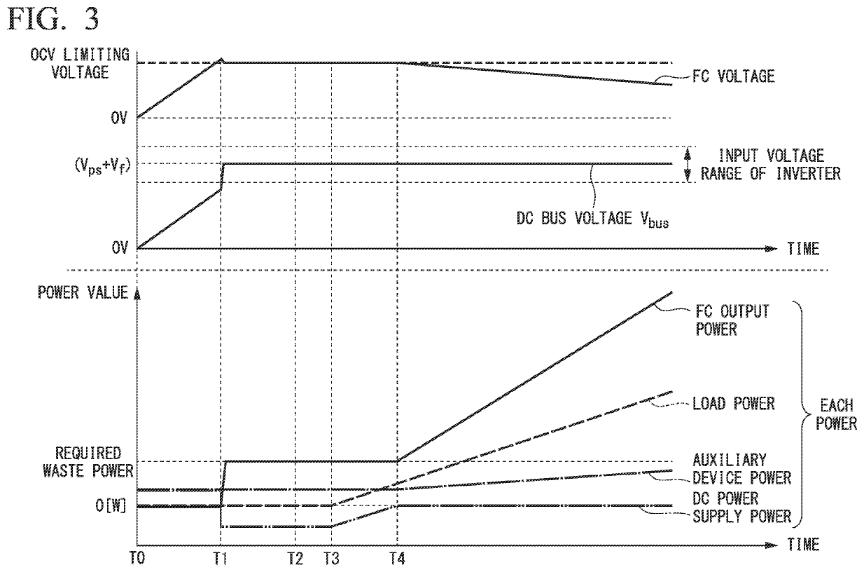

Next, how control is performed when the power supply system 100A is activated will be described with reference to the drawings. FIG. 3 is a diagram for explaining an example of how control is performed when the power supply system 100A is activated. In the example of FIG. 3, the horizontal axis indicates the time and the vertical axis indicates the FC voltage, the DC bus voltage V_{bus}, and power values (FC output power, load power, auxiliary power, and DC power supply power) relating to the power supply system 100A. The FC output power is power output from the FCSs 110. The load power is power supplied to the load. The auxiliary device power is power supplied to the auxiliary devices. The DC power supply power is power output by the regenerative DC power supply 162. Each power value is managed and adjusted by the control device 150A. In FIG. 3, times T0, T1, T2, T3, and T4 are in chronological order with T0 the earliest.

At time T0, the control device 150A activates the power supply system 100A and causes the FCs 112 to generate power. This increases the FC voltage while increasing the DC bus voltage V_{bus} When the FC voltage has increased to the threshold OCV limiting voltage, the power (DC power supply power) from the regenerative DC power supply 162 is supplied to the auxiliary devices as auxiliary device power.

Here, at the time (time T1) when the FC voltage reaches the OCV limiting voltage, the control device 150A starts the OCV limiting control and consumes the power of the FCs 112 without supplying it to the load, auxiliary devices, and the like, that is, wastes the power. In this case, the control device 150A adjusts the DC bus voltage V_{bus} and the FC output power through the voltage clamp circuit 160, for example, such that the DC bus voltage V_{bus} (=V_{f}+Vₚₛ) falls within the input voltage range of the inverter 200 and the FC output power becomes the required waste power. The required waste power is, for example, a minimum required power when performing the OCV limiting control. The required waste power is set for each FC 112. The required waste power is an example of a “target value.” While the OCV limiting control is being performed, part of the FC output power is supplied to the auxiliary devices and the rest is absorbed (consumed) by the regenerative DC power supply 162. In the example of FIG. 3, the state of absorbing power is indicated by a negative power value.

Next, the control device 150A completes the OCV limiting control of the FC voltage at the time T2 when a predetermined period of time has elapsed from the start of the OCV limiting control and starts power supply to the load at the time T3. By starting power supply to the load after a predetermined time has elapsed, it is possible to supply power while both the FC voltage and the DC bus voltage V_{bus} are stable.

When the supply of load power is started at the time T3, the load power increases and the DC power supply power gradually increases, and then at the time T4 when the DC power supply power reaches an initial value (OW), the control device 150A starts FC power control that increases the auxiliary device power and the FC output power. In this case, the control device 150A controls the FC output power, for example, such that its target power is the sum of power supplied to the load and power supplied to the auxiliary devices or the value of waste power required for the voltage clamp circuit 160 to perform OCV limiting control, whichever is higher. As a result, it is possible to supply more appropriate power while securing power that enables the OCV limiting control.

In the example of FIG. 3, from time T4, the FC voltage is consumed as shown in FIG. 2 and decreases below the OCV limiting voltage due to the increase in FC output power and auxiliary power.

As described above, even in the storage-battery-less configuration as shown in FIG. 2, power is constantly supplied from the FCSs 110 to the auxiliary devices via the voltage clamp circuit 160 while the power supply system 100A is active, such that the DC bus voltage V_{bus} can be more stabilized and can be adjusted to fall within the input voltage range of the inverter 200. Adopting the system configuration as shown in FIG. 2 can achieve a reduction in the system size while reducing the cost of equipment such as storage batteries.

### Process Flow

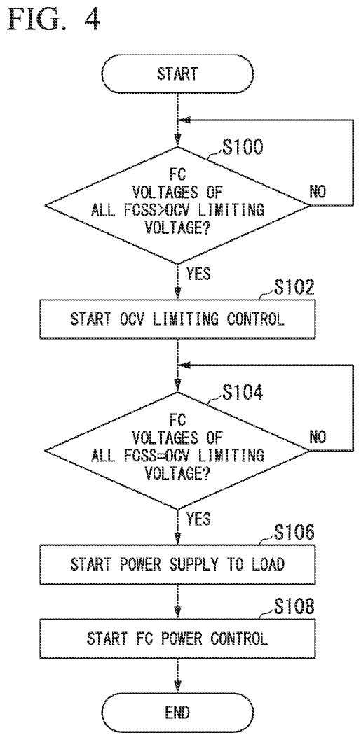

FIG. 4 is a flowchart showing an example of a process performed by the power supply system 100A of the embodiment. The following description will focus on power supply start control that the control device 150A performs in the process performed by the power supply system 100A. The flowchart shown in FIG. 4 shows a process in the configuration in which N FCSs 110 are provided (where N is one or more).

In the example of FIG. 4, after activating the power supply system 100A (particularly, the FCs 112), the control device 150A determines whether the FC voltages of all N FCSs 110 are greater than the OCV limiting voltage (step S100). Upon determining that the FC voltages of all N FCSs 110 are greater than the OCV limiting voltage, the control device 150A causes the voltage clamp circuit 160 to start the OCV limiting control (step S102). A target power of the OCV limiting control is, for example, the required waste power.

Next, the control device 150A determines whether the FC voltages of all FCSs 110 match the OCV limiting voltage (step S104). Matching may include the FC voltage not exceeding the OCV limiting voltage within a predetermined tolerance. Upon determining that the FC voltages of all FCSs 110 match the OCV limiting voltage, the control device 150A starts power supply to the load (step S106). Next, the control device 150A starts FC power control (step S108). A target power in the process of step S108 is, for example, the sum of the load power and the auxiliary power or the required waste power, whichever is higher. Then, the process of this flowchart ends.

According to the embodiment described above, the power supply system 100A includes one or more FCSs (examples of fuel cell outputs) 110, each including a fuel cell (FC) 112 and an FCVCU (an example of a voltage converter) 114 configured to convert an output voltage of the fuel cell, a voltage clamp circuit (an example of a voltage adjuster) 160 connected in parallel with the one or more FCSs 110 to a load, the voltage clamp circuit 160 including a diode 164 and a regenerative DC power supply 162, and a control device 150 configured to control the one or more FCSs 110 and the voltage clamp circuit 160, wherein the control device 150 is configured to perform, after activating the FC 112, limiting control through the voltage clamp circuit 160 such that a voltage of each of the one or more FCSs 110 becomes a target value and start power supply from the one or more FCSs 110 to the load when the voltage of each of the one or more FCSs 110 reaches the target value, whereby the voltage can be stabilized more appropriately even without a storage battery.

Specifically, according to the embodiment, a voltage clamp circuit is configured using a regenerative DC power supply and a diode and auxiliary power is constantly supplied from the FCs via the voltage clamp circuit, such that the DC bus voltage can be stabilized. Thus, according to the embodiment, it is possible to achieve a reduction in the equipment cost and the system size by eliminating the storage battery. According to the embodiment, the voltage is clamped using the auxiliary power, such that it is possible to efficiently stabilize the DC bus voltage, thus contributing to energy efficiency.

The power supply system of the embodiment may be used as an emergency power supply or for regular use. The power supply system of the embodiment may also be used for auxiliary and adjustment purposes such that, in daytime, grid power is supplied to the load, and at night, the power supply system of the embodiment supplies power to the load using fuel such as hydrogen that has been produced using surplus power or the like in daytime. The power supply system of the embodiment need not be stationary.

The embodiment described above can be expressed as follows.

A power supply system includes one or more fuel cell outputs, each including a fuel cell and a voltage converter configured to convert an output voltage of the fuel cell and a voltage adjuster connected in parallel with the one or more fuel cell outputs to a load, the voltage adjuster including a diode and a regenerative DC power supply, the power supply system further including:
a storage medium configured to store computer-readable instructions; and
a processor connected to the storage medium, the processor executing the computer-readable instructions to:
activate the fuel cell;
perform limiting control through the voltage adjuster such that a voltage of each of the one or more fuel cell outputs becomes a target value; and
start power supply from the one or more fuel cell outputs to the load when the voltage of each of the one or more fuel cell outputs reaches the target value.

Although modes for carrying out the present invention have been described above by way of embodiments, the present invention is not limited to these embodiments at all and various modifications and substitutions can be made without departing from the gist of the present invention.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A power supply system comprising:
one or more fuel cell outputs, each including a fuel cell and a voltage converter configured to convert an output voltage of the fuel cell;
a voltage adjuster connected in parallel with the one or more fuel cell outputs to a load, the voltage adjuster including a diode and a regenerative DC power supply; and
a control device configured to control the one or more fuel cell outputs and the voltage adjuster,
wherein the control device is configured to perform, after activating the fuel cell, limiting control through the voltage adjuster such that a voltage of each of the one or more fuel cell outputs becomes a target value and start power supply from the one or more fuel cell outputs to the load when the voltage of each of the one or more fuel cell outputs reaches the target value.

2. The power supply system according to claim 1, wherein the control device is configured to perform control such that power is constantly supplied from the fuel cell to an auxiliary device connected via the voltage adjuster while the power supply system is active.

3. The power supply system according to claim 2, wherein the control device is configured to output, to each of the one or more fuel cell outputs, a command for generating a current corresponding to a sum of power supplied to the load and power supplied to the auxiliary device divided by the number of the fuel cell outputs.

4. The power supply system according to claim 2, wherein the control device is configured to control, after starting power supply from the one or more fuel cell outputs to the load, power output from the one or more fuel cell outputs such that power supplied from the one or more fuel cell outputs is a sum of power supplied to the load and power supplied to the auxiliary device or a value of waste power required for the voltage adjuster to perform limiting control, whichever is higher.

5. A control method for a power supply system including one or more fuel cell outputs, each including a fuel cell and a voltage converter configured to convert an output voltage of the fuel cell, and a voltage adjuster connected in parallel with the one or more fuel cell outputs to a load, the voltage adjuster including a diode and a regenerative DC power supply, the control method comprising:
one or more computers activating the fuel cell;
performing limiting control through the voltage adjuster such that a voltage of each of the one or more fuel cell outputs becomes a target value; and
starting power supply from the one or more fuel cell outputs to the load when the voltage of each of the one or more fuel cell outputs reaches the target value.

6. A computer-readable non-transitory storage medium storing a program for one or more computers in a power supply system including one or more fuel cell outputs, each including a fuel cell and a voltage converter configured to convert an output voltage of the fuel cell, and a voltage adjuster connected in parallel with the one or more fuel cell outputs to a load, the voltage adjuster including a diode and a regenerative DC power supply, the program causing the one or more computers to:
activate the fuel cell;
perform limiting control through the voltage adjuster such that a voltage of each of the one or more fuel cell outputs becomes a target value; and
start power supply from the one or more fuel cell outputs to the load when the voltage of each of the one or more fuel cell outputs reaches the target value.
